(19) United States
(12) Patent Application Publication
(10) Pub. No.: US 2012/0069548 A1
(43) Pub. Date: Mar. 22, 2012

(54) STRUCTURE OF BACK LIGHT PLATE

(76) Inventors: Chien-Yuan Chen, Hsin Tien City (TW); Ying-Te Chuang, Hsin Tien City (TW); Yi-Shen Chen, Hsin Tien City (TW)

(21) Appl. No.: 12/907,043

(22) Filed: Oct. 19, 2010

(30) Foreign Application Priority Data
Sep. 21, 2010 (GB) GB1015736.0

(51) Int. Cl. G02F 1/13357

(52) U.S. Cl. 362/97.1

(57) ABSTRACT

A back light plate includes a plurality of light bars of high light transmittance. The light bars are juxtaposed to form a flat plate like or a grating like light emission structure. Each light bar has opposite ends to which light sources, such as light-emitting diodes, are mounted. Light emitting from the light sources can transmit through the light bar to form a uniform luminous cylinder and thereby constituting a wide span of backlighting. This arrangement saves the number of light-emitting diodes used, makes the manufacturing easy, and provides a simple and convenient-to-carry-out manufacturing process as compared to the conventional manufacturing processes of large-sized thin back light plate, so as to lead to a significant reduction of manufacturing costs.

### (a) TECHNICAL FIELD OF THE INVENTION

The present invention generally relates to a structure of back light plate, and more particularly to a back light source for use in a backlight module of a display screen.

### (b) DESCRIPTION OF THE PRIOR ART

Backlighting is a fashion of lighting used in a liquid crystal display (LCD). The backlighting is realized through a back light plate arranged at the rear side of the LCD, which is a plate like structure that provides lighting and also converts light distribution that is not uniform into uniform lighting.

Conventional back light plates are classified as two types, namely edge type and direct type. Reference is now made to FIG. 7, which shows a back light plate for a large-sized LCD, wherein each of four sides of the back light plate, generally designated at 50, is provided with a powerful light source 60 to supply sufficient emission of light to the back light plate 50. This back light plate has a disadvantage that the use of four light sources increases the costs and further, the central zone is slightly darker. In order to overcome the problem of costs, as shown in FIG. 8, a modified structure of back light plate provides only two light sources 80 on the opposite sides of the plate 70, so that the costs can be reduced. However, the lighting may be insufficient and to overcome such a problem, the plate 70 forms a plurality of densely distributed projections 71, the distribution being increasing denser toward a central zone of the plate for concentration of light on the central zone to improve the problem of non-uniform lighting. But, this raises another problem. The back light plate 70 itself is very thin and the formation of the projections 71 that are distributed with a density variable manner will lead to deformation or cracking due to shrinkage occurring in a molding process and eventually raising the manufacturing costs for the manufacturing requires additional costs of labor and mechanical installation.

A direct type back light plate is shown in FIG. 9, wherein the back light plate 40 forms a plurality of fitting slots 41 each receiving a light-emitting diode 42 to fit therein to form a structure of back light plate having densely distributed spot light sources. The dense arrangement of the light-emitting diodes 42, which may be high power light-emitting diodes, increases the number of parts, makes soldering difficult, and requires high expenses of manufacturing and maintenance. Further, heat dissipation is another problem for the densely arranged light-emitting diodes 42. This is a bottle neck for the technology of large-sized back light plate.

Another direct type of back light plate uses slender lighting tubes as light sources. The problem is that the manufacturing of the slender lighting tubes is difficult and these lighting tubes are easy to break, eventually leading to raised manufacturing costs. This back light plate is of no solution to the existing problems.

Thus, the edge type back light plate is advantageous in reduced labor and reduced material for small sizes, but shows difficult in manufacturing large-sized back light plates and light distribution is not uniform for the large-sized back light plates. The direct type back light plate, although providing more uniform and stronger lighting, has high manufacturing costs and also needs to deal with the problem of heat dissipation.

### SUMMARY OF THE INVENTION

The primary objective of the present invention is to provide a back light plate that comprises a plurality of light bars of high light transmittance. The light bars are juxtaposed to form a flat plate like or a grating like light emission structure. Each light bar has opposite ends to which light sources, such as light-emitting diodes, are mounted. Light emitting from the light sources can transmit through the light bar to form a uniform luminous cylinder and thereby constituting a wide span of backlighting. This arrangement saves the number of light-emitting diodes used, makes the manufacturing easy, and provides a simple and convenient-to-carry-out manufacturing process as compared to the conventional manufacturing processes of large-sized thin plate, so as to lead to a significant reduction of manufacturing costs.

Another objective of the present invention is to provide a back light plate, which comprises a plurality of light bars of high light transmittance and wherein the light bars form a plurality of light concentration spots that is of a dense distribution at a location distant from a light source so that the portion of the light bars that is originally weak of lighting cab be provided with brightness of substantially the same level as the remaining portions of the light bars due to the arrangement of the light concentration spots thereby providing excellent result of uniform mixture of light.

A further objective of the present invention is to provide a back light plate that comprises a plurality of light bars of high light transmittance and a reflection film is formed on a top side of the light bars to force the light to emit outward from a bottom side of the light bars to thereby enhance the brightness and also eliminate the use of a conventionally used reflector plate.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a structure of back light plate according to the present invention.

FIG. 2 is a plan view of the back light plate according to the present invention.

FIG. 3 is an exploded view of a light bar that constitutes in part the back light plate according to the present invention.

FIG. 4 is a cross-sectional view showing a practical application of the back light plate according to the present invention.

FIG. 5 is a perspective view of a portion of a modified embodiment of the back light plate according to the present invention.

FIG. 6 is a perspective view showing a structure of back light plate according to another embodiment of the present invention.

FIG. 7 is a schematic plan view of a conventional edge type back light plate.

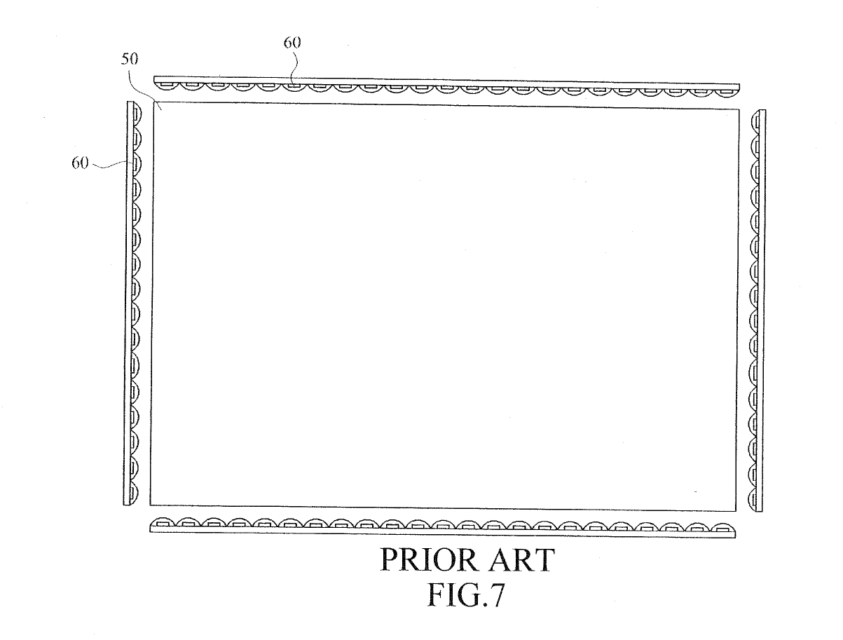

FIG. 8 is a schematic plan view of another conventional edge type back light plate.

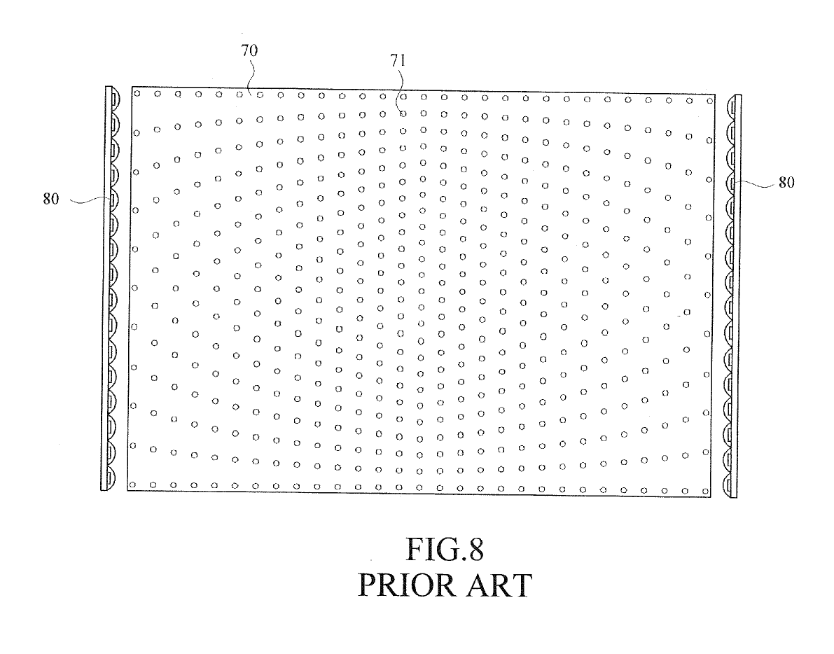

FIG. 9 is a schematic plan view of a conventional direct type back light plate.

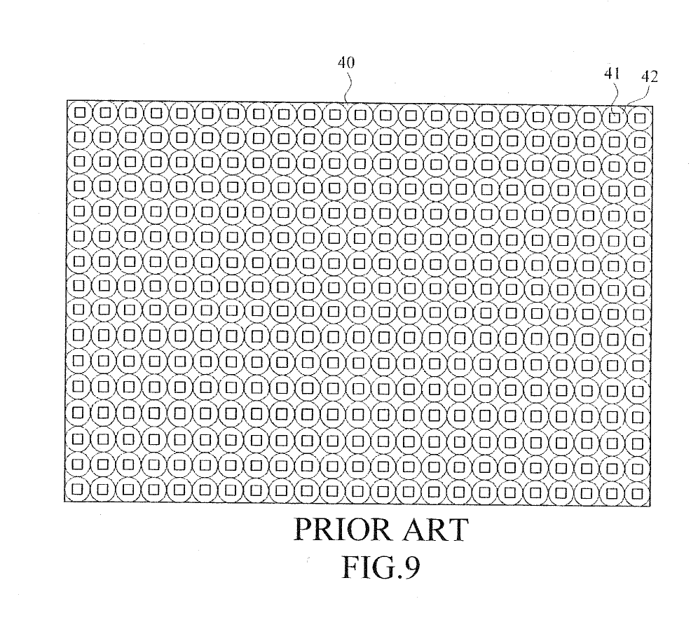

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

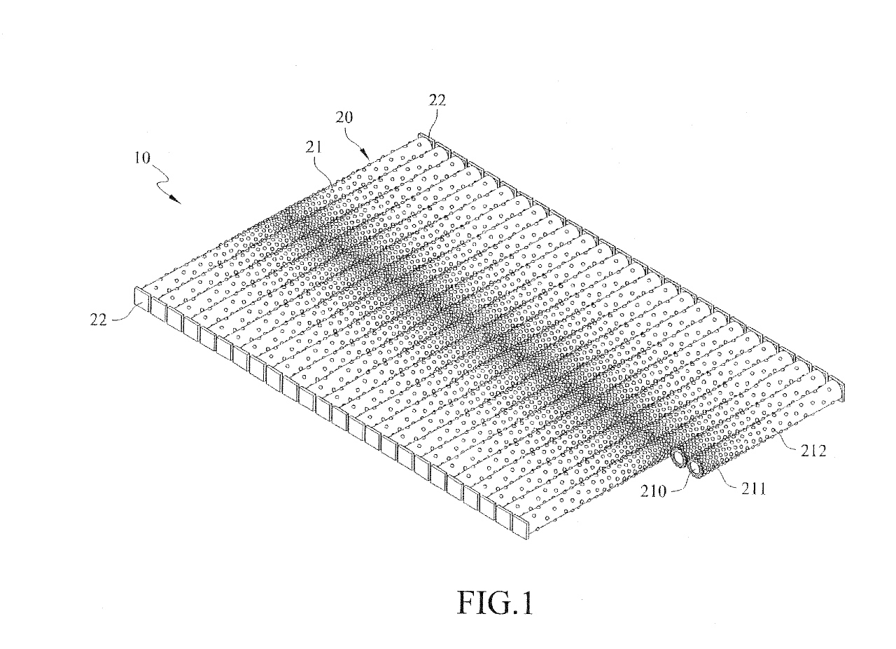

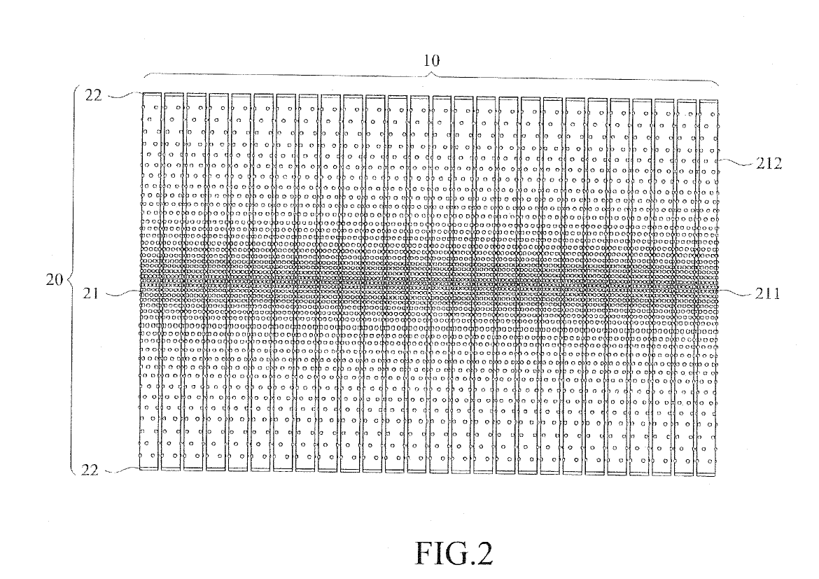

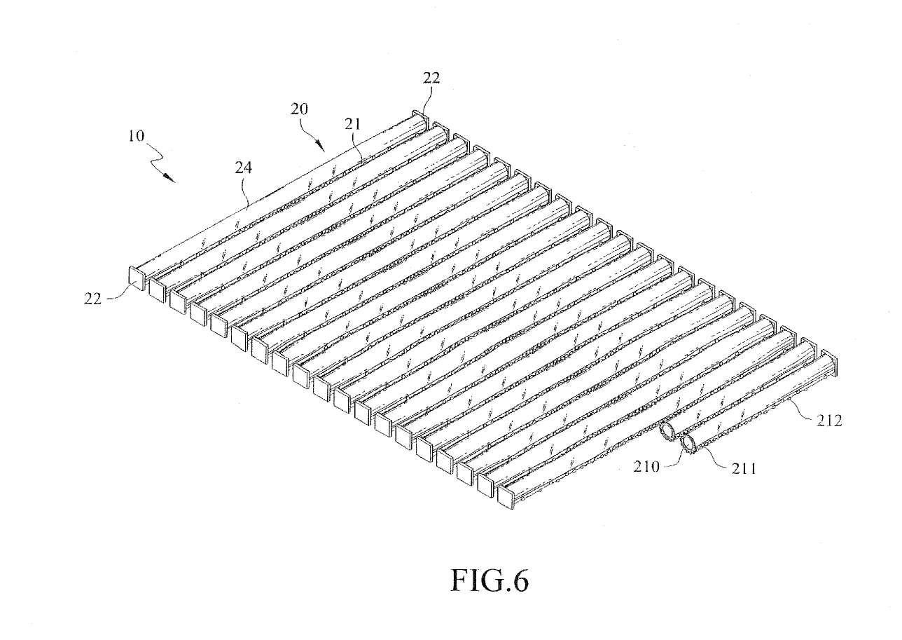

Referring to FIGS. 1 and 2, the present invention provides a back light plate 10, which comprises a plurality of light bars 20 of high light transmittance arranged closely to juxtapose each other to form a flat plate like light emission structure, or alternatively, as shown in FIG. 6, spaced from each other by a predetermined interval to form a grating like light emission structure.

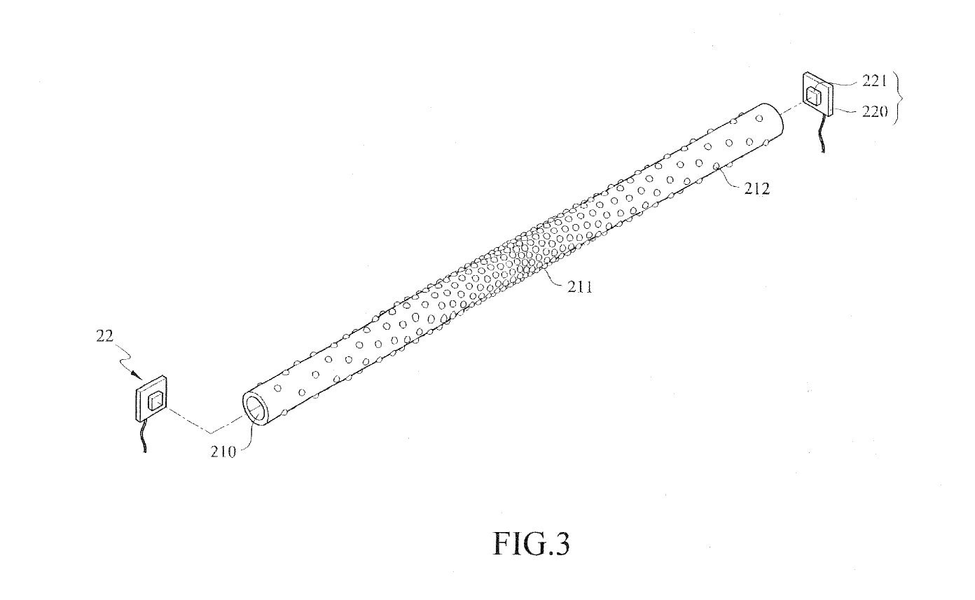

Referring to FIGS. 1 and 3, the light bar 20 is structurally different from a regular lighting tube in that the light bar 20 comprises a flexible light transmitting tubular body 21 forming centrally bore 210 that extends axially through the light bar. The tubular body 21 has an outer circumferential surface on which a plurality of light concentration spots 211, 212 is formed. For better uniform distribution of light emitting from the outer surface of the tubular body 21, the plurality of light concentration spots 211 formed on a central portion of the tubular body is distributed in a denser manner that the distribution of the light concentration spots 212 formed on opposite end portions of the tubular body 21, and the change of distribution is made in a gradually increasing manner, as shown in FIGS. 2 and 3. Further, the tubular body 21 of each light bar 20 has two opposite ends to each or any of which a light source 22 is mounted. The light source 22 comprises at least one light-emitting diode (LED) 221 and a control circuit board 220. The number of LED 221 used for each light source can be increased or decreased as desired according to a practical requirement. An example of a single LED 221 is taken in the embodiment illustrated for explanation of the present invention. Further, the LED 221 can be of any desired specification and there is no constraint for that. For example, the LED 22 can be a surface-mounted LED or a two-pin through-hole type LED.

The light bar 20 is made as a structure of flexible material. This allows the light bars 20 to be of certain flexibility for bending as desired. Further, the light bars are made of materials of high light transmittance, so that bending of the light bar does not significantly affect the optic characteristics of light transmittance and light conduction. Thus, the present invention is a breakthrough of the known techniques and a novel creation.

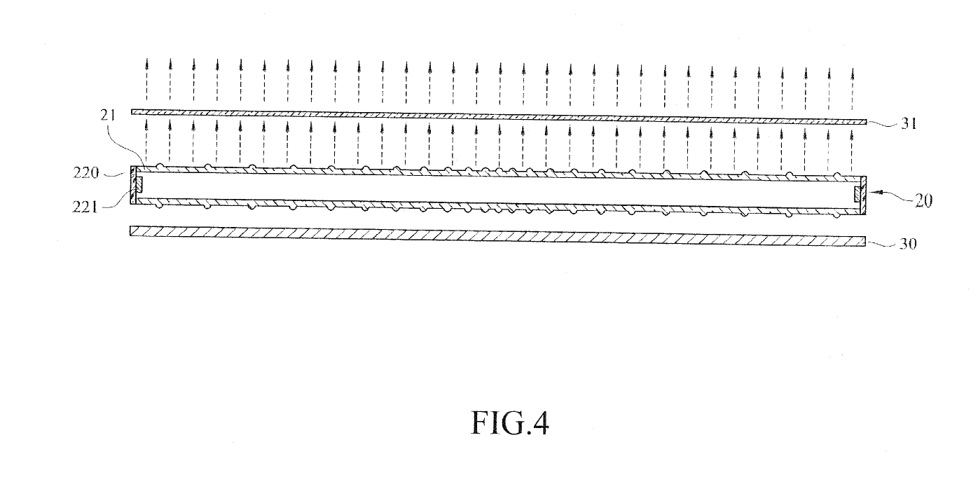

To use the present invention, as shown in FIG. 4, reference also being had to FIGS. 1-3, the back light plate 10 composed of a plurality of light bars 20 can be combined with a polarizing plate 31 set on a front surface thereof and a reflection plate 30 set on a rear surface thereof. The reflection plate 30 has a high reflection surface and can be made in the form of a curved shape, such as paraboloid, that reflects light back to the front side of the back light plate. Thus, the plurality of light bars 20 of high light transmittance, after emission of light from the light sources 22 mounted to the ends of each of the light bars 20, guides the light through the tubular body 21 to form an elongate luminous cylinder. The light is made uniform by the density variable arrangement of light concentration spots 211, 212, whereby the light bars 20, each of which provides uniform emission of light therefrom, are composed together to form a back light plate 10 of a desired width.

Referring to FIG. 6, the light bars 20 are each provided with a reflection film 24 that is coated on or attached to a side surface of the light bar, so that light is only allowed to emit outward from an opposite side surface of the light bar 20. This improves the brightness and also eliminates the use of the reflection plate 30 shown in FIG. 4, making the back light plate 10 itself light reflective on the rear side thereof as shown in FIG. 6, eventually reducing the overall thickness of a display screen to which the back light plate is applied.

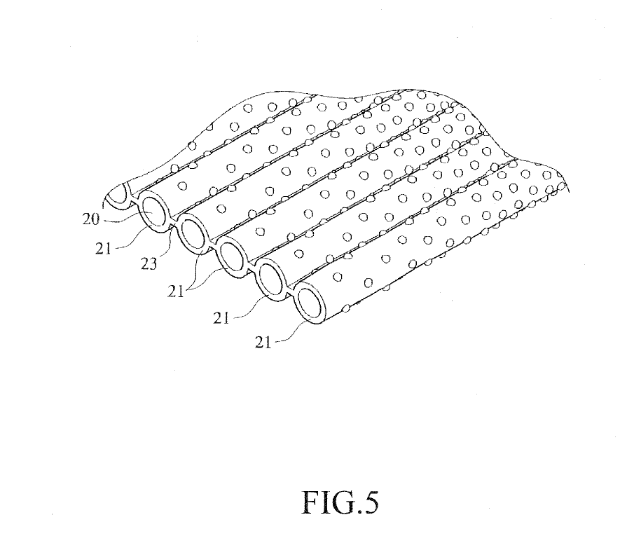

In the structural arrangement of the present invention, such as the juxtaposed light bars 20 shown in FIG. 1 or 6, the opposite ends of the arrangement of the light bars can be retained and fixed by clamping devices, which are known in the field and are thus not shown in the drawings. Further, the plurality of light bars 20 can be formed integrally through injection molding, as illustrated in FIG. 5, where when the light bars 20 are formed by injection molding, point connections or an axially-extending linear connection can be formed between adjacent ones of the light bars to facilitate and speed up the manufacturing thereof.

The light bar 20 preferably has a cross-sectional shape of circle, but other shapes, such as rectangular, square, and symmetric polygonal shapes, can be taken as the cross-section of the light bar 20. Preferably, the light bar 20 is clear or transparent, but it is also feasible to make the light bar with a light color. The light bar 20 can be formed as a tubular body through injection molding, or alternatively, the light bar can be formed by wrapping a thin film to form a tube, this being easily inferred from the known manufacturing techniques. All these can be easily figured out from reading the above description and such simple and easy modifications or variations are believed to be well within the scope of the present invention.

In summary, the present invention offers the following advantages:

(1) The present invention provides a back light plate that is formed by composing a plurality of light bars, which is made of a material selected from currently available materials, so that there will be no potential shortage of supply of the material. Further, the light bars can be individually manufactured and the combined together, or they can be integrally formed through injection molding, so that as compared to the conventional ways of making thin and large-sized plate structure, the present invention makes the manufacturing easy, costs reduced, percentage of flaw products lowered down, and processing and handling simple and easy. This is the primary advantage of the present invention.

(2) When compared to a direct type back light plate, a large number of LEDs are saved and the costs of parts and processing are reduced, but the same advantages of uniform emission of light and similar performance can be obtained and the problem of heat dissipation is small. This is another advantage of the present invention.

(3) When compared to the conventional edge type back light plate, the present invention provides a design that saves parts costs as compared to the design having light sources on four sides and that makes the manufacturing easy as compared to the dual-surface type large-sized thin plate and the product flaw rate is low, the manufacturing and assembling of the parts are simple. This is a further advantage of the present invention.

(4) The present invention provides a reflection film covering a top surface of the light bars to force the light bars to emit light through a bottom surface. This not only increases the brightness, but also eliminates the conventionally used reflector plate, making the overall thickness of a display screen smaller. This is yet a further advantage of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A back light plate comprising a plurality of light bars made of a material of high light transmittance, the light bars being arranged to juxtapose each other with a predetermined interval therebetween to form a grating like light emission structure.

2. The back light plate according to claim 1, wherein the predetermined interval between adjacent light bars is substantially zero so that the light bars are closely juxtaposed to form a flat plate like structure.

3. The back light plate according to claim 1, wherein each of the light bars comprises a tubular body having opposite ends to each of which a light source is mounted, the light source comprising at least one light-emitting diode and a control circuit board.

4. The back light plate according to claim 1, wherein at least one of the light bars comprises a plurality of light concentration spots formed thereon.

5. The back light plate according to claim 4, wherein the light concentration spots are arranged in a density variable distribution on the light bar.

6. The back light plate according to claim 4, wherein the light concentration spots comprise a first portion that is of a dense distribution on a central portion of the light bar and a second portion that is of a spare distribution on opposite end portions of the light bar.

7. The back light plate according to claim 1, further comprising a reflection film set on a side surface of the light bars.

8. The back light plate according to claim 1, wherein the plurality of light bars forms a plurality of light concentration spots thereon.

9. The back light plate according to claim 1, wherein the light bars have a circular cross-section.

10. The back light plate according to claim 1, wherein the light bars have a square or rectangular cross-section.

11. The back light plate according to claim 1, wherein the light bars have a symmetric polygonal cross-section.

12. The back light plate according to claim 2, wherein the closely juxtaposed light bars comprise a connection between adjacent light bars.

13. The back light plate according to claim 2, wherein the closely juxtaposed light bars comprise point connections between adjacent light bars.

14. The back light plate according to claim 2, wherein the closely juxtaposed light bars comprise a linear connection between adjacent light bars.

15. The back light plate according to claim 1, wherein the light bars are of color.

16. The back light plate according to claim 1, wherein the light bars are transparent.

17. The back light plate according to claim 1, wherein the light bars each form a central bore axially extending therethrough.

18. The back light plate according to claim 1 further comprising a reflection plate arranged on a rear side of the plurality of light bars.

19. The back light plate according to claim 1, wherein opposite ends of the light bars are retained by clamping devices.

20. The back light plate according to claim 1, wherein the light bars are made of a flexible material of high light transmittance.

21. A back light plate comprising a plurality of light bars that is juxtaposed to form a flat plate like or a grating like light emission structure, each of the light bars comprising a tubular body having opposite ends to each of which a light source is mounted, the light source comprising at least one light-emitting diode and a control circuit board.
